(19) United States
(12) Patent Application Publication
(10) Pub. No.: US 2026/0367691 A1
(43) Pub. Date: Nov. 19, 2026

(54) SYSTEMS AND METHODS TO GENERATE PIECEWISE LINEAR VOLTAGE/CURRENT REFERENCES FOR MEMORY CIRCUITS

(71) Applicant: Ambiq Micro, Inc., Austin, TX (US)

(72) Inventors: Ivan Bogue, Austin, TX (US); Ivan Kochkin, Austin, TX (US); Scott McLean Hanson, Austin, TX (US); Daniel Martin Cermak, Austin, TX (US); Anshuman Singh, Austin, TX (US)

(21) Appl. No.: 19/210,744

(22) Filed: May 16, 2025

(51) Int. Cl. G06F 1/3234; G06F 1/3296

(52) U.S. Cl. CPC G06F 1/3275; G06F 1/3243; G06F 1/3296

(57) ABSTRACT

A circuit for generating a piecewise-linear current is provided. The circuit includes a first input port, a second input port, an output port configured to provide the piecewise-linear current, and a first circuit stage coupled to the first input port and the second input port. The first input stage is configured to generate a first stage output voltage. The first stage output voltage is proportional to a difference between a voltage on the first input port and a voltage on the second input port. The circuit further includes a second circuit stage coupled to the first stage output voltage and the output port. The second circuit stage is configured to generate the piecewise-linear current from the first stage output voltage.

### TECHNICAL FIELD

The present disclosure relates generally to system on chip microcontrollers. More particularly, aspects of this disclosure relate to a system that reduces power consumption for a memory module in a microcontroller system by providing a piecewise linear voltage reference circuit that varies power supplied to the memory module.

### BACKGROUND

In recent years, due to the growth of portable electronics, there has been a push to decrease the power used by microcontrollers (or “MCU”), microprocessors, application processors, digital signal processors (DSPs), neural processing units (NPUs), and other circuits used in portable electronic appliances. With lower power requirements, effective electronics operation time can be extended, or alternatively, smaller batteries can be used. Commonly, the power consumption of a microcontroller and associated circuits may be reduced by using a lower supply voltage, or by reducing the amount of internal capacitance being charged and discharged during the operation of the circuit.

One method for reducing microcontroller power relies on hardware or software-based power mode switching. Power modes can be selected for microcontroller components or resources based on operating state, operating conditions, and/or sleep cycle characteristics and other factors to configure low power modes for selected microcontroller components at the time the processor enters a low power or sleep state. In some systems, a set of predefined low power configurations can be used, while more sophisticated systems can dynamically select low power configurations to maximize power savings while still meeting system latency requirements.

Currently, the voltage applied to all memory cells in a memory module in the microcontroller system is a single voltage for all the bitcells during various operating modes. The operating modes may be power modes such as an active mode, a standby mode, and a deep sleep mode. The retention voltage for the entire memory chip is traditionally determined using the single worst case bitcell at the worst case process corner at the chip level. The retention voltage is typically set and unchanged after memory fabrication and production. Accordingly, it is desirable to have a microcontroller system that provides a reliable overall power management protocol and reduces power consumption for the memory chips therein by further adjusting the retention voltage after production.

### SUMMARY

The term embodiment and like terms, e.g., implementation, configuration, aspect, example, and option, are intended to refer broadly to all of the subject matter of this disclosure and the claims below. Statements containing these terms should be understood not to limit the subject matter described herein or to limit the meaning or scope of the claims below. Embodiments of the present disclosure covered herein are defined by the claims below, not this summary. This summary is a high-level overview of various aspects of the disclosure and introduces some of the concepts that are further described in the Detailed Description section below. This summary is not intended to identify key or essential features of the claimed subject matter. This summary is also not intended to be used in isolation to determine the scope of the claimed subject matter. The subject matter should be understood by reference to appropriate portions of the entire specification of this disclosure, any or all drawings, and each claim.

According to certain aspects of the present disclosure, a circuit for generating a piecewise-linear current is provided. The circuit includes a first input port, a second input port, an output port configured to provide the piecewise-linear current, and a first circuit stage coupled to the first input port and the second input port. The first input stage is configured to generate a first stage output voltage. The first stage output voltage is proportional to a difference between a voltage on the first input port and a voltage on the second input port. The circuit further includes a second circuit stage coupled to the first stage output voltage and the output port. The second circuit stage is configured to generate the piecewise-linear current from the first stage output voltage.

In another disclosed implementation of the example circuit, the voltage on the first input port is constant with respect to a first temperature range and a second temperature range, and the voltage on the second input port varies with respect to the first temperature range and the second temperature range. In another disclosed implementation, the voltage on the second input port changes at a same rate with respect to the first temperature range and the second temperature range. In another disclosed implementation, the piecewise-linear current decreases with respect to the first temperature range and remains constant with respect to the second temperature range. In another disclosed implementation, the piecewise-linear current is 0 in the second temperature range. In another disclosed implementation, the piecewise-linear current remains constant with respect to the first temperature range and increases with respect to the second temperature range. In another disclosed implementation, temperature where the voltage on the second input port is equal to the voltage on the first input port is greater than any temperature in the first temperature range. In another disclosed implementation, the first temperature range and the second temperature range define an operating range for an on-chip memory. In another disclosed implementation, the on-chip memory is an SRAM.

In another disclosed implementation, the first circuit stage includes a first input transistor, a second input transistor source-coupled to the first input transistor, and a tail current component coupled to sources of both the first input transistor and the second input transistor. The gate of the first input transistor is the first input port. The gate of the second input transistor is the second input port. In another disclosed implementation, the tail current component is one of a resistor, a current source, or a transistor. In another disclosed implementation, the system further includes a current mirror coupled to drains of both the first input transistor and the second input transistor such that voltage at the drain of the second input transistor is the first stage output voltage. In another disclosed implementation, the second circuit stage includes a second current mirror. The second current mirror generates the piecewise-linear current from the first stage output voltage. In another disclosed implementation, the first stage output voltage is coupled to a gate of an output transistor in the second current mirror. A drain of the output transistor is the output port.

According to certain aspects of the present disclosure, a system for generating different supply voltage operation modes for a memory is provided. The system includes a first input port, a piecewise-linear current generator, an amplifier stage, and an auxiliary switch. The amplifier stage includes an amplifier input coupled to the first input port, an auxiliary current port, and an amplifier output coupled to the auxiliary current port. The auxiliary switch is coupled to the auxiliary current port. The auxiliary switch is configured to (i) connect the piecewise-linear current generator to the auxiliary current port based on an auxiliary switch enable signal being asserted and (ii) disconnect the piecewise-linear current generator from the auxiliary current port based on the auxiliary switch enable signal being deasserted. Magnitude of a voltage at the amplifier output is determined as (a) magnitude of a voltage of the amplifier input scaled by a gain of the amplifier when the piecewise-linear current generator is disconnected from the auxiliary current port or (b) a sum of the magnitude of the voltage of the amplifier input scaled by the gain of the amplifier and a scaled magnitude of piecewise-linear current provided by the piecewise-linear current generator when the piecewise-linear current generator is connected to the auxiliary current port.

In another disclosed implementation of the example system, the system further includes a first switch coupled to the amplifier input and the first input port. The first switch is configured to (i) connect the first input port to the amplifier input based on a first switch enable signal being asserted and (ii) disconnect the first input port from the amplifier input based on the first switch enable signal being deasserted. In another disclosed implementation, the system further includes a second input port and a second switch. The second switch is coupled to the amplifier input and the second input port. The second switch is configured to (i) connect the second input port to the amplifier input based on a second switch enable signal being asserted and (ii) disconnect the second input port from the amplifier input based on the second switch enable signal being deasserted. In another disclosed implementation, only one of the first switch enable signal or the second switch enable signal is asserted. In another disclosed implementation, voltage on the second input port varies with respect to a first temperature range and a second temperature range. In another disclosed implementation, voltage on the first input port is constant with respect to the first temperature range and the second temperature range. In another disclosed implementation, voltage on the first input port is constant with respect to a first temperature range and a second temperature range.

In another disclosed implementation, the piecewise-linear current generator includes a first generator input port, a second generator input port, a generator output port configured to provide the piecewise-linear current, and a first circuit stage coupled to the first generator input port and the second generator input port. The first input stage is configured to generate a first stage output voltage. The first stage output voltage is proportional to a difference between a voltage on the first generator input port and a voltage on the second generator input port. The piecewise-linear current generator further includes a second circuit stage coupled to the first stage output voltage and the generator output port. The second circuit stage is configured to generate the piecewise-linear current from the first stage output voltage. In another disclosed implementation, the system further includes a plurality of input ports including the first input port and a multiplexer coupled to the amplifier input and the plurality of input ports. The multiplexer is configured to connect the amplifier input to one input port in the plurality of input ports based on a select signal of the multiplexer.

### BRIEF DESCRIPTION OF THE DRAWINGS

The disclosure will be better understood from the following description of exemplary embodiments together with reference to the accompanying drawings, in which:

FIG. 1 is a block diagram of the example low power microcontroller system, according to certain aspects of the present disclosure.

FIG. 2 is a block diagram of an example analog module that supplies power, external signals, and clock signals to the low power microcontroller system in FIG. 1, according to certain aspects of the present disclosure.

FIG. 3 is a schematic block diagram of a circuit architecture for generating a piecewise-linear reference, according to certain aspects of the present disclosure.

FIG. 4 is a schematic diagram of a circuit for generating a piecewise-linear current reference, according to certain aspects of the present disclosure.

FIG. 5 is a graph showing a first piecewise-linear current vs. temperature relationship for inputs and outputs of a piecewise-linear current reference, according to certain aspects of the present disclosure.

FIG. 6A is a graph showing a second piecewise-linear current vs. temperature relationship for inputs and outputs of a piecewise-linear current reference, according to certain aspects of the present disclosure.

FIG. 6B is a graph showing a third piecewise-linear current vs. temperature relationship for inputs and outputs of a piecewise-linear current reference, according to certain aspects of the present disclosure.

FIG. 7 is a first circuit architecture of a system for generating different supply voltage operation modes for a memory, according to certain aspects of the present disclosure.

FIG. 8 is a first circuit for generating different supply voltage operation modes for a memory, according to certain aspects of the present disclosure.

FIG. 9 is a second circuit for generating different supply voltage operation modes for a memory, according to certain aspects of the present disclosure.

FIG. 10 is a second circuit architecture of a system for generating different supply voltage operation modes for a memory, according to certain aspects of the present disclosure.

FIG. 11 is a graph showing a fourth piecewise-linear current vs. temperature relationship for inputs and outputs of a piecewise-linear current reference, according to certain aspects of the present disclosure

The present disclosure is susceptible to various modifications and alternative forms, and some representative embodiments have been shown by way of example in the drawings and will be described in detail herein. It should be understood, however, that the invention is not intended to be limited to the particular forms disclosed. Rather, the disclosure is to cover all modifications, equivalents, and alternatives falling within the spirit and scope of the invention as defined by the appended claims.

### DETAILED DESCRIPTION OF THE ILLUSTRATED EMBODIMENTS

Various embodiments are described with reference to the attached figures, where like reference numerals are used throughout the figures to designate similar or equivalent elements. The figures are not necessarily drawn to scale and are provided merely to illustrate aspects and features of the present disclosure. Numerous specific details, relationships, and methods are set forth to provide a full understanding of certain aspects and features of the present disclosure, although one having ordinary skill in the relevant art will recognize that these aspects and features can be practiced without one or more of the specific details, with other relationships, or with other methods. In some instances, well-known structures or operations are not shown in detail for illustrative purposes. The various embodiments disclosed herein are not necessarily limited by the illustrated ordering of acts or events, as some acts may occur in different orders and/or concurrently with other acts or events. Furthermore, not all illustrated acts or events are necessarily required to implement certain aspects and features of the present disclosure.

For purposes of the present detailed description, unless specifically disclaimed, and where appropriate, the singular includes the plural and vice versa. The word “including” means “including without limitation.” Moreover, words of approximation, such as “about,” “almost,” “substantially,” “approximately,” and the like, can be used herein to mean “at,” “near,” “nearly at,” “within 3-5% of,” “within acceptable manufacturing tolerances of,” or any logical combination thereof. Similarly, terms “vertical” or “horizontal” are intended to additionally include “within 3-5% of” a vertical or horizontal orientation, respectively. Additionally, words of direction, such as “top,” “bottom,” “left,” “right,” “above,” and “below” are intended to relate to the equivalent direction as depicted in a reference illustration; as understood contextually from the object(s) or element(s) being referenced, such as from a commonly used position for the object(s) or element(s); or as otherwise described herein. Further, it is noted that the term “signal” means a waveform (e.g., electrical, optical, magnetic, mechanical or electromagnetic) capable of traveling through a medium such as DC, AC, sinusoidal-wave, triangular-wave, square-wave, vibration, and the like.

Embodiments of this disclosure relate to a circuit for generating a piecewise-linear reference current for memory or memory modules. The circuit monitors temperature of the memory and adjusts the reference current according to a piecewise-linear relationship between the reference current and the monitored temperature. This results in being able to account for temperature effects that may affect optimal retention voltage for the memory module, thereby being able to significantly reducing power consumption of the microcontroller system.

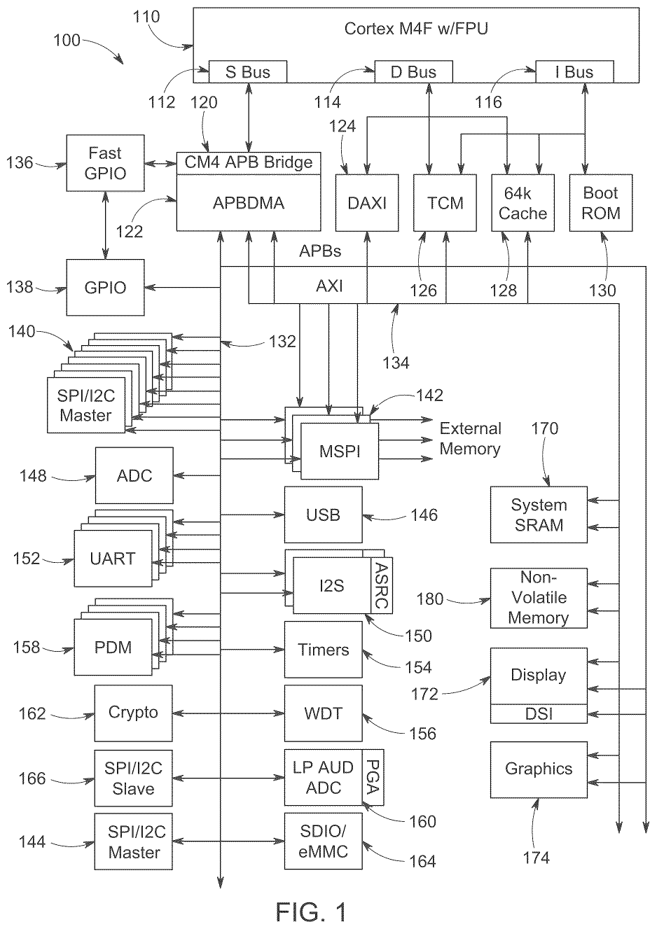

FIG. 1 is a block diagram of an example low power microcontroller system 100. The low power microcontroller system 100 includes a central processing unit (CPU) 110. In some embodiments, the CPU 110 in this example is Cortex M4F (CM4) with a floating point unit. The CPU 110 includes a System-bus interface 112, a Data-bus interface 114, and an Instruction-bus interface 116. It is to be understood, that other types of general CPUs, or other processors such as DSPs or NPUs may incorporate the principles described herein.

The System-bus interface 112 is coupled to a Cortex M4 advanced peripheral bus (APB) bridge 120 that is coupled to an advanced peripheral bus (APB) direct memory access (DMA) module 122. The microcontroller system 100 includes a Data Advanced extensible Interface (DAXI) 124, a tightly coupled memory (TCM) 126, a cache 128, and a boot ROM 130. The Data-bus interface 114 allows access to the DAXI 124, the TCM 126, the cache 128, and the boot read only memory (ROM) 130. The Instruction-bus interface 116 allows access to the TCM 126, the cache 128, and the boot ROM 130. In this example, the DAXI interface 124 provides write buffering and caching functionality for the microcontroller system 100. The DAXI interface 124 improves performance when accessing peripherals like the SRAM and the MSPIs.

An Advanced Peripheral Bus (APB) 132 and an Advanced extensible Interface (AXI) bus 134 are provided for communication between components on the microcontroller system 100. The APB 132 is a low speed and low overhead interface that is used for communicating with peripherals and registers that do not require high performance and do not change often (e.g., when a controller wants to set configuration bits for a serial interface). The AXI bus 134 is an ARM standard bus protocol that allows high speed communications between multiple masters and multiple busses. This is useful for peripherals that exchange large amounts of data (e.g., a controller that talks to an ADC and needs to transfer ADC readings to a microcontroller or a GPU that talks to a memory and needs to transfer a large amount of graphics data to/from memories).

A fast general purpose input/output (GPIO) module 136 is coupled to the APB bridge 120. A GPIO module 138 is coupled to the fast GPIO module 136. The APB 132 is coupled to the GPIO module 138. The APB 132 is coupled to a series of Serial Peripheral Interface/Inter-Integrated Circuit (SPI/I2C) interfaces 140 and a series of Multi-bit Serial Peripheral Interfaces (MSPI)s 142. The MSPIs 142 are also coupled to the AXI bus 134 and provide access to external memory devices.

The APB 132 is also coupled to a SPI/I2C interface 144, a universal serial bus (USB) interface 146, an analog to digital converter (ADC) 148, an Integrated Inter-IC Sound Bus (I2S) interface 150, a set of Universal Asynchronous Receiver/Transmitters (UART) s 152, a timer module 154, a watch dog timer circuit 156, a series of pulse density modulation (PDM) interfaces 158, a low power audio ADC 160, a cryptography module 162, a Secure Digital Input Output/Embedded Multi-Media Card (SDIO/eMMC) interface 164, and a SPI/I2C slave interface module 166. The PDM interfaces 158 may be connected to external digital microphones. The low power audio ADC 160 may be connected to an external analog microphone through internal programmable gain amplifiers (PGA).

A system non-volatile memory (NVM), which is 2 MB in size in this example, is accessible through the AXI bus 134. A system static random access memory (SRAM) 170, which is 1 MB in this example is accessible through the AXI bus 134. The microcontroller system 100 further includes a display interface 172 and a graphics interface 174 that are coupled to the APB bus 132 and the AXI bus 134. The microcontroller system 100 can also include a nonvolatile memory 180.

Components of the disclosed microcontroller system 100 are further described by U.S. Provisional Ser. No. 62/557,534, titled “Very Low Power Microcontroller System,” filed Sep. 12, 2017; U.S. application Ser. No. 15/933,153, filed Mar. 22, 2018 titled “Very Low Power Microcontroller System,” (Now U.S. Pat. No. 10,754,414), U.S. Provisional Ser. No. 62/066,218, titled “Method and Apparatus for Use in Low Power Integrated Circuit,” filed Oct. 20, 2014; U.S. application Ser. No. 14/855,195, titled “Peripheral Clock Management,” (Now U.S. Pat. No. 9,703,313), filed Sep. 15, 2015; U.S. application Ser. No. 15/516,883, titled “Adaptive Voltage Converter,” (Now U.S. Pat. No. 10,338,632), filed Sep. 15, 2015; U.S. application Ser. No. 14/918,406, titled “Low Power Asynchronous Counters in a Synchronous System,” (Now U.S. Pat. No. 9,772,648), filed Oct. 20, 2015; U.S. application Ser. No. 14/918,397, titled “Low Power Autonomous Peripheral Management,” (Now U.S. Pat. No. 9,880,583), filed Oct. 20, 2015; U.S. application Ser. No. 14/879,863, titled “Low Power Automatic Calibration Method for High Frequency Oscillators,” (Now U.S. Pat. No. 9,939,839), filed Oct. 9, 2015; U.S. application Ser. No. 14/918,437, titled “Method and Apparatus for Monitoring Energy Consumption,” (Now U.S. Pat. No. 10,578,656), filed Oct. 20, 2015; U.S. application Ser. No. 17/081,378, titled “Improved Voice Activity Detection Using Zero Crossing Detection,” filed Oct. 27, 2020, U.S. application Ser. No. 17/081,640, titled “Low Complexity Voice Activity Detection Algorithm,” filed Oct. 27, 2020, all of which are hereby incorporated by reference.

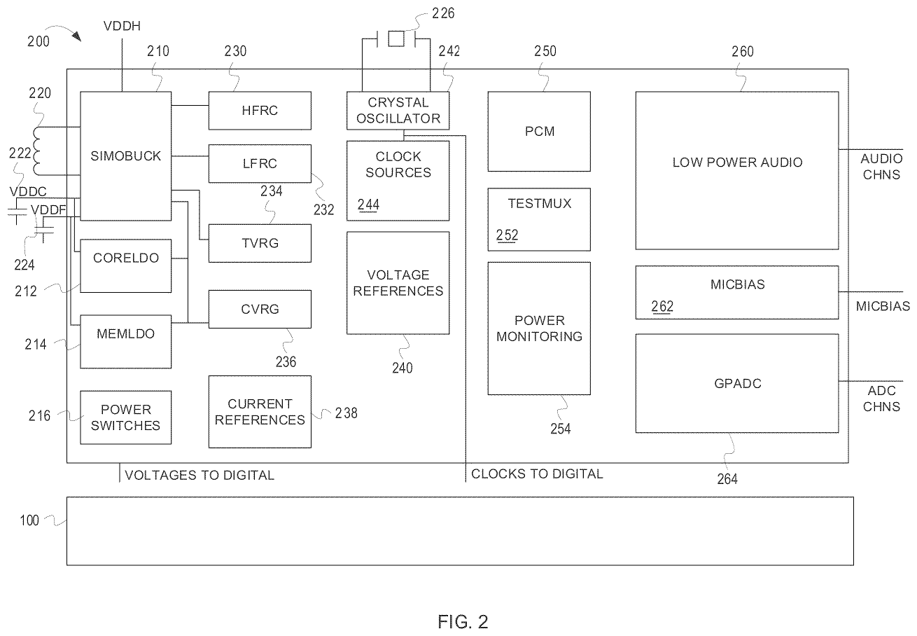

FIG. 2 shows a block diagram of an analog module 200 that interfaces external components with the microcontroller system 100 in FIG. 1. The analog module 200 supplies power to different components of the microcontroller system 100 as well as providing clocking signals to the microcontroller system 100. The analog module 200 includes a Single Inductor Multiple Output (SIMO) buck converter 210, a core low drop-out (LDO) voltage regulator 212, and a memory LDO voltage regulator 214. The SIMO buck converter 210 supplies DC voltage at different levels to components and devices of the microcontroller system 100 in FIG. 1 and the analog module 200 in FIG. 2. The LDO voltage regulator 212 supplies power to processor cores of the microcontroller system 100, while the memory LDO voltage regulator 214 supplies power to volatile memory devices of the microcontroller system 100, such as the SRAM 170. A switch module 216 represents switches that allow connection of power to the different components of the microcontroller system 100.

The SIMO buck converter 210 is coupled to an external inductor 220. The analog module 200 is coupled to a core VDD (VDDC) capacitor 222 and a memory VDD (VDDF) capacitor 224. The VDDC capacitor 222 smooths the voltage output of the core LDO voltage regulator 212 and the SIMO buck converter 210. The VDDF capacitor 224 smooths the voltage output of the memory LDO voltage regulator 214 and the SIMO buck converter 210. The analog module 200 is also coupled to an external crystal 226.

The SIMO buck converter 210 is coupled to a high frequency resistor-capacitor (HFRC) oscillator circuit 230, a low frequency resistor-capacitor (LFRC) circuit 232, and a temperature-sensitive voltage reference generator (TVRG) circuit 234. A calibrated voltage reference generator (CVRG) circuit 236 is coupled to the SIMO buck converter 210, the core LDO voltage regulator 212, and the memory LDO voltage regulator 214. Thus, both voltage compensation and temperature compensation are performed on the voltage sources. A set of current reference circuits 238 is provided as well as a set of voltage reference circuits 240.

In this example, the LDO voltage regulators 212, 214 are optionally used to power up the microcontroller system 100. The more efficient SIMO buck converter 210 is preferably used to power the same components.

A crystal oscillator circuit 242 is coupled to the external crystal 226. The crystal oscillator circuit 242, LFRC oscillator 232, and HFRC oscillator 230 together serve as a set of clock sources 244. The clock sources 244 include multiple clocks providing different frequency signals to the components on the microcontroller system 100.

The analog module 200 also includes a process control monitor (PCM) 250 and a test multiplexor 252. Both the PCM 250 and the test multiplexor 252 allow testing and trimming of the microcontroller system 100 prior to shipment. The PCM 250 includes test structure that allow programming of the compensation voltage regulator 236. The test multiplexor 252 allows trimming of different components on the microcontroller system 100. The analog module 200 includes a power monitoring module 254 that allows power levels to different components on the microcontroller system 100 to be monitored. The power monitoring module 254, in this example, includes multiple state machines that determine when power is required by different components of the microcontroller system 100. The power switch module 216 connects voltages generated by the SIMO buck converter 210 and LDOs 212 and 214 with voltage rails that support components of the microcontroller system 100. The analog module 200 includes a low power audio module 260 for audio channels, a microphone bias module 262 for biasing external microphones, and a general purpose analog to digital converter 264.

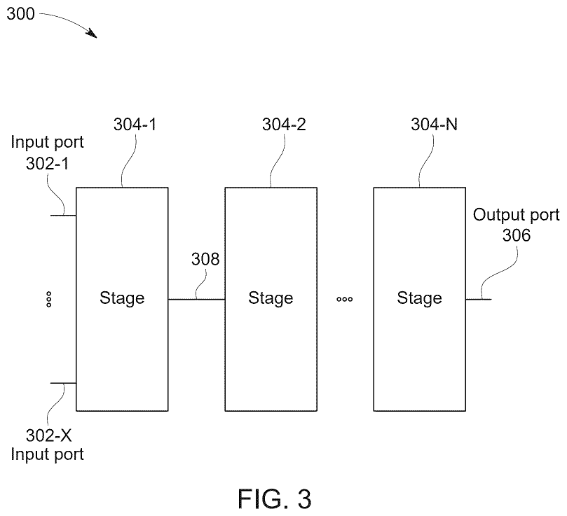

FIG. 3 is a schematic block diagram of a circuit architecture 300 for generating a piecewise reference (e.g., a piecewise-linear reference), according to certain aspects of the present disclosure. The piecewise-linear reference can be a voltage reference or a current reference. For example, the piecewise-linear reference can be one or more of the voltage or current references in the low power microcontroller system 100 (FIG. 1). The piecewise-linear reference can be one or more voltage or current references or part of one or more voltage or current references in the analog module 200 (FIG. 2). For example, the piecewise-linear reference can be used in the set of current reference circuits 238 (FIG. 2) and/or the set of voltage reference circuits 240 (FIG. 2). The circuit architecture 300 includes two or more input ports (e.g., input ports 302-1, . . . 302-X) and an output port 306. The circuit architecture 300 generates a voltage reference level or a current reference level at the output port 306 using voltages and/or current inputs at the input ports 302-1, . . . 302-X.

In some implementations, the SIMO buck converter 210 (FIG. 2), which is the main voltage source of the microcontroller system 100 can use the reference level at the output port 306. In some implementations, a voltage regulator such as, but not limited to, a low dropout regulator (LDO) (e.g., the core LDO voltage regulator 212, the memory LDO voltage regulator 214, etc.), switched capacitance converter, or another step-down voltage regulator can use the reference level at the output port 306.

The circuit architecture 300 can include two or more stages 304-1, 304-2, . . . 304-N to facilitate generating the voltage reference level or the current reference level at the output port 306. Each stage in the two or more stages 304-1, 304-2, . . . 304-N generates at least one stage output signal. Stage output signals from a previous stage are fed into a next stage. For example, stage 304-1 can generate one or more stage output signals 308 that feed into stage 304-2. Stage output signals of a final stage (e.g., stage 304-N) include the voltage or current at the output port 306. In some implementations, the final stage only has one output signal (i.e., the voltage or current at the output port 306). The voltage or current at the output port 306 can have a piecewise behavior with respect to temperature where in an operating temperature range, the voltage or current can be described using two or more of the following: (i) constant, (ii) falling with a constant slope, (iii) rising with a constant slope, (iv) falling with a changing slope, or (v) rising with a changing slope. The voltage or current at the output port 306 can have a piecewise-linear behavior with respect to temperature where in an operating temperature range, the voltage or current can be described using two or more of the following: (i) constant, (ii) falling with a constant slope, or (iii) rising with a constant slope.

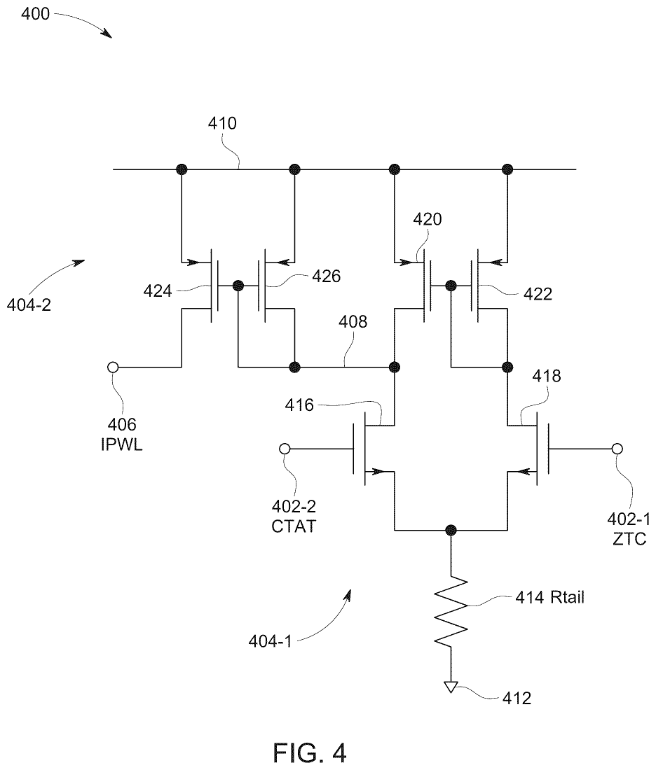

To further illustrate benefits associated with the circuit architecture 300, FIG. 4 provides a schematic diagram of a circuit 400 for generating a piecewise-linear current reference, according to certain aspects of the present disclosure. The circuit 400 includes a first circuit stage 404-1 and a second circuit stage 404-2. Inputs to the first circuit stage include a first input port 402-1 and a second input port 402-2. In some implementations, the first input port 402-1 receives a zero-temperature coefficient voltage (ZTC) input and the second input port 402-2 receives a complementary to absolute temperature (CTAT) input. The first circuit stage 404-1 receives inputs at the first input port 402-1 and the second input port 402-2 and generates a first stage output voltage at node 408. The first stage output voltage at node 408 is fed to the second circuit stage 404-2. The second circuit stage 404-2 uses the voltage at node 408 to generate a piecewise-linear current (IPWL) at an output port 406. Voltage rails for the circuit 400 can be provided at power terminals 410, 412.

In some implementations, the ZTC input at the first input port 402-1 of the first circuit stage 404-1 is a voltage input, and the CTAT input at the second input port 402-2 of the first circuit stage 404-1 is also a voltage input. The first circuit stage 404-1 controls the voltage at node 408 such that the voltage at node 408 is proportional to a difference between the voltage inputs at the first input port 402-1 and the second input port 402-2. The second circuit stage 404-2 is coupled to the voltage at node 408. The second circuit stage 404-2 is configured to generate the piecewise-linear current at the output port 406 from the voltage at node 408.

In some implementations, the first circuit stage 404-1 includes a first input transistor 418 and as second input transistor 416. The gate voltage at the first input transistor 418 can be voltage of the first input port 402-1. The gate voltage at the second input transistor can be voltage of the second input port 402-2. In some implementations, source terminals of the first input transistor 418 and the second input transistor 416 are coupled together. In some implementations, the coupled source terminals of the first input transistor 418 and the second input transistor 416 are coupled to a tail current component 414. The tail current component 414 can be, for example, a tail resistor (e.g., Rtail), a current source, and/or a transistor.

In some implementations, the first circuit stage 404-1 includes a load portion. In some implementations, the load portion is a current mirror. The current mirror can include a first load transistor 422 and a second load transistor 420. In some implementations, the current mirror is coupled to drains of both the first input transistor 418 and the second input transistor 416 such that the voltage at node 408 is the voltage at the coupled drains of the second load transistor 420 and the second input transistor 416.

In some implementations, the second circuit stage 404-2 includes a second current mirror. The second current mirror can include transistors 426, 424. The voltage at node 408 can be coupled to the gates of the transistors 426, 424. The drain of the transistor 424 can be provided as the output port 406 such that current flowing through the transistor 424 is the piecewise-linear current.

In some implementations, the circuit configuration of FIG. 4 with a resistor Rtail as the tail current component 414 provides the following relationship:

$$IPWL = \{ \begin{matrix}\frac{CTAT - ZTC}{Rtail} , & CTAT > ZTC \\ 0 , & CTAT < ZTC\end{matrix} \qquad ( Eq . 1 )$$

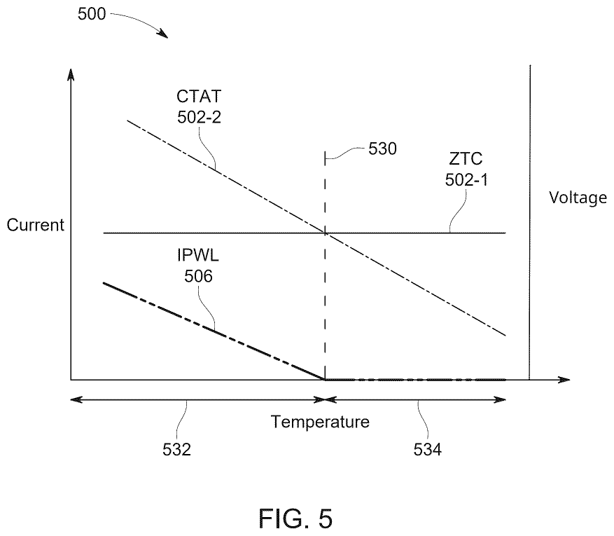

FIG. 5 a graph 500 showing a first piecewise-linear current vs. temperature relationship for inputs (ZTC 502-1 and CTAT 502-2) and output (IPWL 506) of a piecewise-linear current reference, according to certain aspects of the present disclosure. The piecewise-linear current reference can be, for example, the circuit 400 or have an architecture like that of the circuit architecture 300. The graph 500 shows that magnitude of CTAT 502-2 decreases as temperature increases, and the magnitude of ZTC 502-1 remains constant as temperature increases. CTAT 502-2 and/or ZTC 502-1 can be current inputs, voltage inputs, etc. In the circuit 400 example, CTAT 502-2 and ZTC 502-1 are voltage inputs. FIG. 5 is adapted to correspond to FIG. 4 such that CTAT 502-2 and ZTC 502-1 are voltages represented by the right axis, and IPWL 506 is a current represented in the left axis.

In some implementations, there is a temperature 530 where the magnitudes of both CTAT 502-2 and ZTC 502-1 are equal. This temperature 530 divides the temperature range into a first temperature range 532 and a second temperature range 534. ZTC 502-1 is constant with respect to the first temperature range 532 and the second temperature range 534. CTAT 502-2 varies in both the first temperature range 532 and the second temperature range 534. In some implementations, CTAT 502-2 changes at a same rate with respect to the first temperature range 532 and the second temperature range 534.

When these inputs (CTAT 502-2 and ZTC 502-1) are used to create a piecewise-linear current reference, the output IPWL 506 exhibits a behavior that the piecewise-linear current decreases with respect to the first temperature range 532 and remains constant with respect to the second temperature range 534. In some implementations, as provided in Eq. 1 and the graph 500, the output IPWL 506 in the second temperature range 534 can be 0. In some implementations, the first temperature range 532 and the second temperature range 534 are modeled to match an operating temperature range of an on-chip memory.

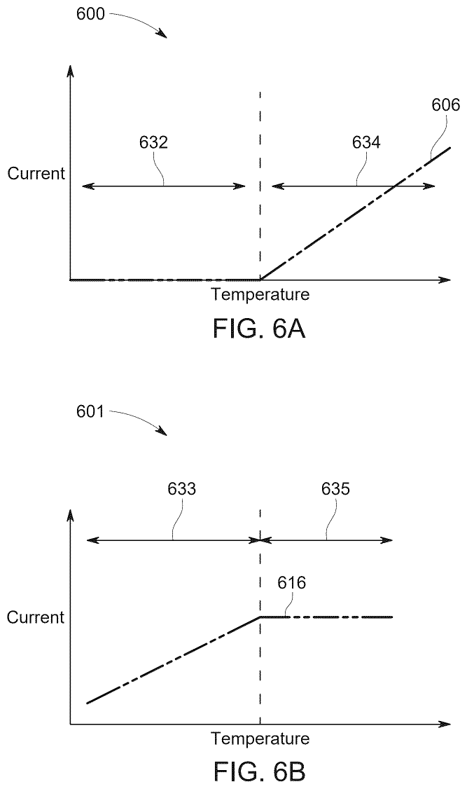

The circuit architecture 300 can be used to generate other piecewise-linear current behavior. For example, circuit components in the circuit 400 can be rearranged to provide the example piecewise-linear current behaviors in FIGS. 6A and 6B. FIG. 6A is a graph 600 showing a second piecewise-linear current vs. temperature relationship for inputs and output 606 of a piecewise-linear current reference, according to certain aspects of the present disclosure. In FIG. 6A, the output 606 during a first temperature range 632 is constant and rises during a second temperature range 634. FIG. 6B is a graph 601 showing a third piecewise-linear current vs. temperature relationship for inputs and output 616 of a piecewise-linear current reference, according to certain aspects of the present disclosure. In FIG. 6A, the output 616 rises during a first temperature range 633 is constant during a second temperature range 635.

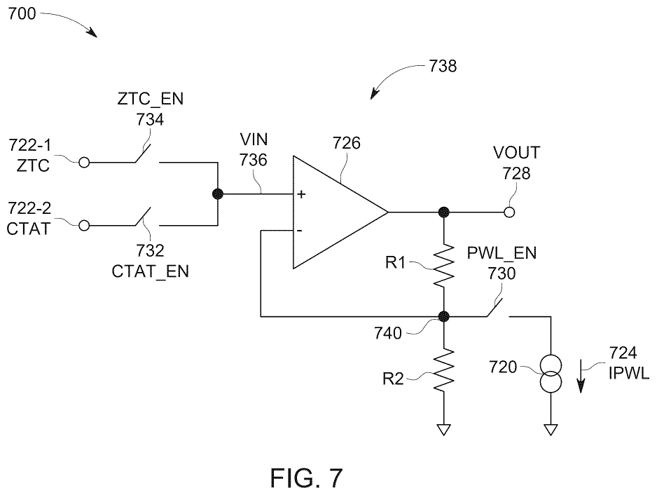

FIG. 7 is a circuit architecture of a system 700 for generating different supply voltage operation modes for a memory, according to certain aspects of the present disclosure. The system 700 includes a first input port 722-1, a piecewise-linear current generator 720, an amplifier stage 738, and an auxiliary switch 730. The amplifier stage 738 is configured to set voltage and/or current at an output port 728. The piecewise-linear current generator 720 is coupled to the amplifier stage 738 via the auxiliary switch 730 to adjust the voltage and/or current at the output port 728. The first input port 722-1 is coupled to an amplifier input 736 of the amplifier stage 738 such that the voltage or current at the first input port 722-1 can influence the amplifier input 736.

In some implementations, the amplifier stage 738 includes an auxiliary current port 740. The auxiliary switch 730 couples the piecewise-linear current generator 720 to the amplifier stage 738 at the auxiliary current port 740. In some implementations, an amplifier output is the same as the output port 728. In some implementations, the amplifier stage 738 includes an operational amplifier 726 in an amplifier topology. For example, the topology can be an inverting amplifier topology or a non-inverting amplifier topology. The topology can include resistors, capacitors, inductors, etc. The topology can include multiple amplifier stages, a buffer stage, etc. In FIG. 7, the system 700 provides resistors R1 and R2 as components where resistor R1 is coupled to the output port 728 and the auxiliary current port 740. The resistor R2 is coupled to a ground reference and the auxiliary current port 740.

The auxiliary switch 730 connects the piecewise-linear current generator 720 to the auxiliary current port 740 based on an auxiliary switch enable signal (e.g., PWL_EN) being asserted. The current flowing through the piecewise-linear current generator 720 is IPWL 724. The auxiliary switch 730 disconnects the piecewise-linear current generator 720 from the auxiliary current port 740 based on PWL_EN being deasserted. In some cases, magnitude of a voltage at the output port 728 is determined as magnitude of a voltage of the amplifier input 736 scaled by a gain of the amplifier stage 738 when the piecewise-linear current generator 720 is disconnected from the auxiliary current port 740. In some cases, the magnitude of the voltage at the output port 728 is a sum of the magnitude of the voltage of the amplifier input 738 scaled by the gain of the amplifier stage 738 and a scaled magnitude of a piecewise-linear current (IPWL 724) provided by the piecewise-linear current generator 720 when the piecewise-linear current generator 720 is connected to the auxiliary current port 740.

In some implementations, the system 700 further includes a first switch 734 that couples the amplifier input 736 to the first input port 722-1. The first switch 734 connects the first input port 722-1 to the amplifier input 736 based on a first switch enable signal (e.g., ZTC_EN) being asserted. The first switch 734 disconnects the first input port 722-1 from the amplifier input 736 based on ZTC_EN being deasserted.

In some implementations, the system 700 further includes a second input port 722-2 that is coupled to the amplifier input 736 via a second switch 732. The second switch 732 connects the second input port 722-2 to the amplifier input 736 based on a second switch enable signal (e.g., CTAT_EN) being asserted. The second switch 732 disconnects the second input port 722-2 from the amplifier input 736 based on CTAT_EN being deasserted.

The system 700 can be used to generate different output voltage behavior based on combinations of switches being asserted or deasserted. For example, the following modes can be provided by the system 700—(a) Zero TC Mode: VOUT=ZTC*(1+R1/R2); ZTC_EN=ON, CTAT_EN=OFF, PWL_EN=OFF; (b) CTAT Mode: VOUT=CTAT*(1+R1/R2); ZTC_EN=OFF, CTAT_EN=ON, PWL_EN=OFF; (c) PWL Mode: VOUT=ZTC*(1+R1/R2)+IPWL*R1; ZTC_EN=ON, CTAT_EN=OFF, PWL_EN=ON.

Although system 700 provides two input ports (the first input port 722-1 and the second input port 722-2), more than two input ports can be provided. A multiplexer or a decoder can be provided to control switches associated with the input ports. The multiplexer or the decoder can allow one or more of the switches to be asserted or deasserted to adjust which input ports are coupled to the amplifier stage input 736. Select signals can be used to control the multiplexer or decoder to control which of the switches are asserted or deasserted.

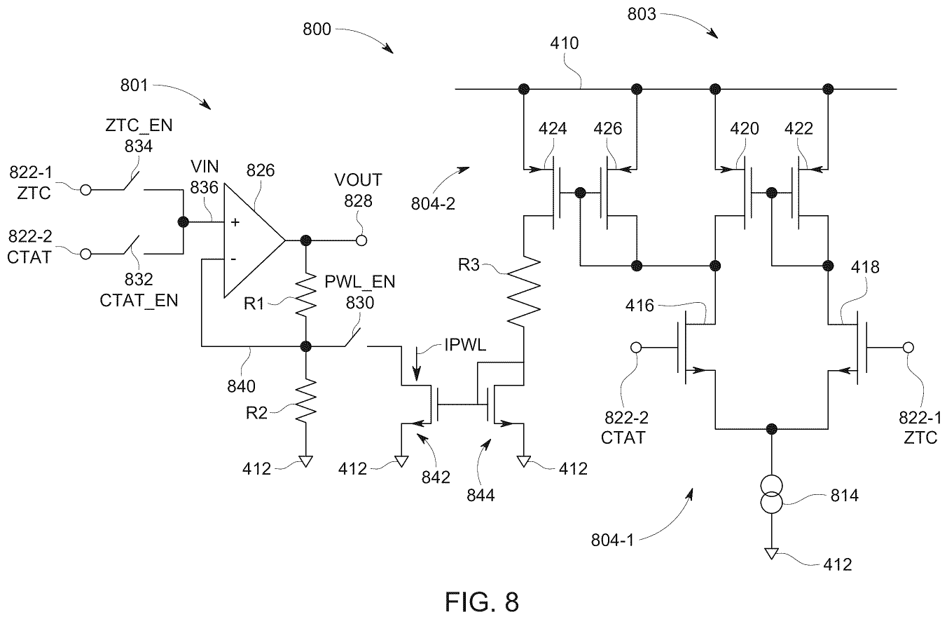

FIG. 8 is a circuit 800 for generating different supply voltage operation modes for a memory, according to certain aspects of the present disclosure. The circuit 800 includes a first portion 801 and a second portion 803. The first portion 801 is similar to or the same as the system 700 (FIG. 7), and the second portion 803 is similar to or the same as the circuit 400. Compared to the system 700, the piecewise-linear current generator 720 is replaced with the second portion 803 such that the piecewise-linear current IPWL is the current flowing through transistor 842.

The first portion 801 has inputs 822-1 and 822-2. These are analogous to the inputs 722-1 and 722-2 in FIG. 7. Switches 834, 832, and 830 provide similar functionality as the first switch 734, the second switch 732, and the auxiliary switch 730, respectively. Operational amplifier 826 and VIN 836 are substantially the same as described above in connection with the operational amplifier 726 and the amplifier input 736. An output port 828 provides a voltage output in one of three modes as provided above in connection with FIG. 7. For example, the output port 828 can provide an output voltage in Zero TC Mode, CTAT Mode or PWL Mode. The circuit 800 further includes an auxiliary port 840 for interfacing the first portion 801 to the second portion 803.

The second portion 802 includes a first stage 804-1 and a second stage 804-2. The first stage 804-1 is similar to the first stage 404-1 (FIG. 4). The first stage 804-1 includes a symbol for a current source 814. The second stage 804-2 is different from that of FIG. 4 in that it further includes a resistor R3 and transistor 844. The transistors 844, 842 form a current mirror. As provided in FIG. 8, the circuit 800 can generate IPWL flowing through the transistor 842 having the behavior depicted in FIG. 5 as the output IPWL 506. If the inputs to the input transistors 416 and 418 are switched (i.e., CTAT 822-2 is inputted to the first input transistor 418 and ZTC 822-1 is inputted to the second input transistor 416), the circuit 800 generates IPWL flowing through the transistor 842 having the behavior depicted in FIG. 6A as the output 606.

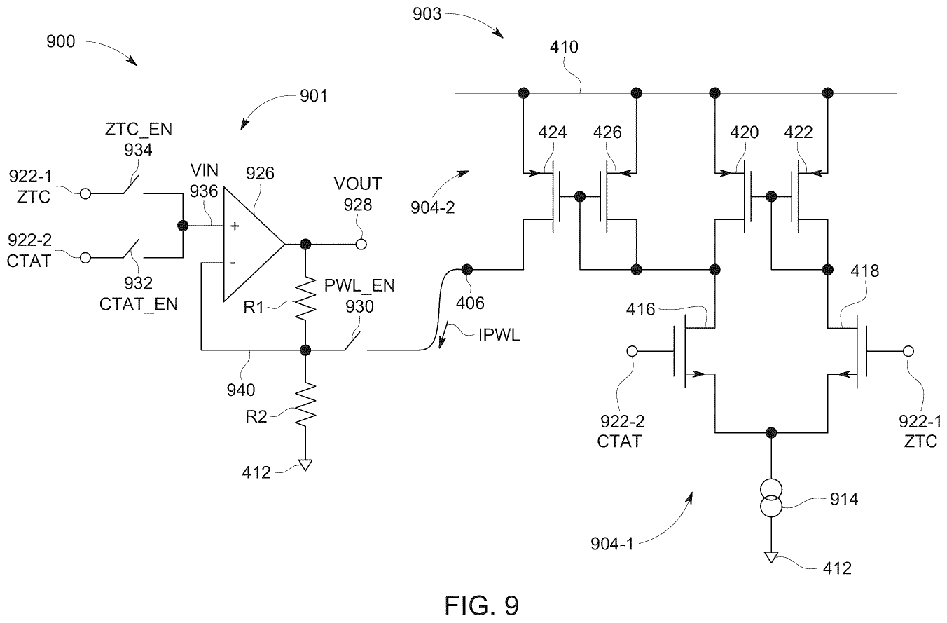

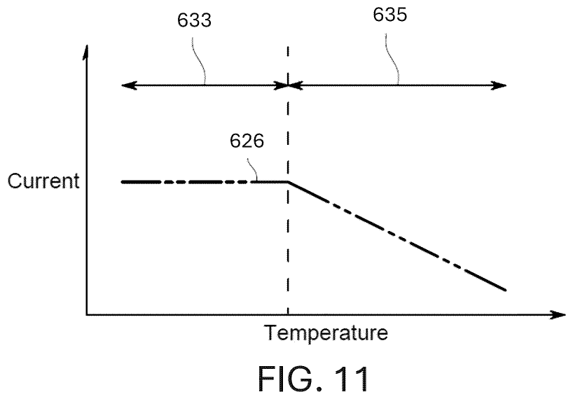

IPWL does not always have to be connected to the terminal 412. FIG. 9 is a circuit 900 for generating different supply voltage operation modes for a memory, according to certain aspects of the present disclosure. The circuit 900 includes a first portion 901 and a second portion 903. The first portion 901 includes switches 930, 932, 934, VIN 936, an output port 928, an amplifier 926, and an auxiliary port 940. The first portion further includes a current source 914. The second portion 903 includes a first stage 904-1 and a second stage 904-2. The second stage 904-2 is similar to the second stage 404-2 (FIG. 4). The output port 406 of the second stage 404-2 connects to the switch 930. Inputs 922-1 and 922-2 are provided to the circuit 900 to generate an output voltage at the output port 928. The circuit 900 can be used to generate IPWL flowing out of the output port 406 such that the output voltage at the output port 928 follows the behavior depicted in FIG. 6B as the output 616. If the inputs to the input transistors 416 and 418 are switched (i.e., CTAT 922-2 is inputted to the first input transistor 418 and ZTC 922-1 is inputted to the second input transistor 416), the circuit 900 generates IPWL flowing out of the output port 928 such that the output voltage at the output port 928 follows the behavior depicted in FIG. 11 as output 626.

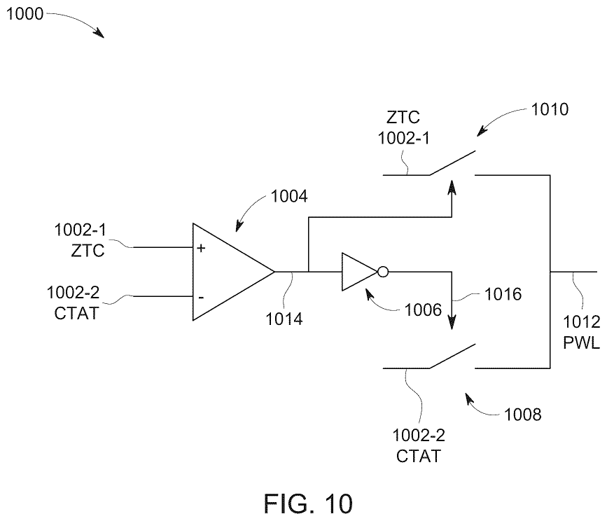

FIG. 10 is a circuit architecture 1000 of a system for generating different supply voltage operation modes for a memory, according to certain aspects of the present disclosure. Input voltages 1002-1 and 1002-2 are used to generate output voltage 1012. The output voltage 1012 is a piecewise-linear output voltage when the input voltages 1002-1 and 1002-2 exhibit behaviors of ZTC and CTAT as described above in connection with FIG. 5. The circuit architecture 1000 includes a comparator 1004 that generates a comparator output used as a select signal 1014. The select signal 1014 is inverted using an inverter 1006 to obtain an inverted select signal 1016. Switches 1010 and 1008 are controlled by the select signal 1014 and the inverted select signal 1016, respectively. The switches 1010, 1008 allow either the input voltage 1002-1 to pass or the input voltage 1002-2 to pass. The circuit architecture 1000 can be used to generate a voltage behavior similar to that of FIGS. 5 and 6A.

As used in this application, the terms “component,” “module,” “system,” or the like, generally refer to a computer-related entity, either hardware (e.g., a circuit), a combination of hardware and software, software, or an entity related to an operational machine with one or more specific functionalities. For example, a component may be, but is not limited to being, a process running on a processor (e.g., digital signal processor), a processor, an object, an executable, a thread of execution, a program, and/or a computer. By way of illustration, both an application running on a controller, as well as the controller, can be a component. One or more components may reside within a process and/or thread of execution, and a component may be localized on one computer and/or distributed between two or more computers. Further, a “device” can come in the form of specially designed hardware, generalized hardware made specialized by the execution of software thereon that enables the hardware to perform specific function, software stored on a computer-readable medium, or a combination thereof.

The terminology used herein is for the purpose of describing particular embodiments only, and is not intended to be limiting of the invention. As used herein, the singular forms “a,” “an,” and “the” are intended to include the plural forms as well, unless the context clearly indicates otherwise. Furthermore, to the extent that the terms “including,” “includes,” “having,” “has,” “with,” or variants thereof, are used in either the detailed description and/or the claims, such terms are intended to be inclusive in a manner similar to the term “comprising.”

Unless otherwise defined, all terms (including technical and scientific terms) used herein have the same meaning as commonly understood by one of ordinary skill in the art. Furthermore, terms, such as those defined in commonly used dictionaries, should be interpreted as having a meaning that is consistent with their meaning in the context of the relevant art, and will not be interpreted in an idealized or overly formal sense unless expressly so defined herein.

While various embodiments of the present invention have been described above, it should be understood that they have been presented by way of example only, and not limitation. Although the invention has been illustrated and described with respect to one or more implementations, equivalent alterations and modifications will occur or be known to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application. Thus, the breadth and scope of the present invention should not be limited by any of the above described embodiments. Rather, the scope of the invention should be defined in accordance with the following claims and their equivalents.

1. A circuit for generating a piecewise-linear current, comprising:
a first input port;
a second input port;
an output port configured to provide the piecewise-linear current;
a first circuit stage coupled to the first input port and the second input port,
the first input stage configured to generate a first stage output voltage,
the first stage output voltage being proportional to a difference between a voltage on the first input port and a voltage on the second input port; and
a second circuit stage coupled to the first stage output voltage and the output port,
the second circuit stage configured to generate the piecewise-linear current from the first stage output voltage.

2. The circuit according to claim 1, wherein the voltage on the first input port is constant with respect to temperature, and wherein the voltage on the second input port varies with respect to temperature.

3. The circuit according to claim 2, wherein the voltage on the second input port changes at a same rate with respect to a first temperature range and a second temperature range.

4. The circuit according to claim 3, wherein the piecewise-linear current decreases with respect to the first temperature range and remains constant with respect to the second temperature range.

5. The circuit according to claim 4, wherein the piecewise-linear current is 0 in the second temperature range.

6. The circuit according to claim 3, wherein the piecewise-linear current remains constant with respect to the first temperature range and increases with respect to the second temperature range.

7. The circuit according to claim 3, wherein temperature where the voltage on the second input port is equal to the voltage on the first input port is greater than any temperature in the first temperature range.

8. The circuit according to claim 3, wherein the first temperature range and the second temperature range define an operating range for an on-chip memory.

9. The circuit according to claim 8, wherein the on-chip memory is an SRAM.

10. The circuit according to claim 1, wherein the first circuit stage comprises:
a first input transistor, the gate of the first input transistor being the first input port;
a second input transistor source-coupled to the first input transistor, the gate of the second input transistor being the second input port; and
a tail current component coupled to sources of both the first input transistor and the second input transistor.

11. The circuit according to claim 10, wherein the tail current component is one of a resistor, a current source, or a transistor.

12. The circuit according to claim 10, further comprising:
a current mirror coupled to drains of both the first input transistor and the second input transistor such that voltage at the drain of the second input transistor is the first stage output voltage.

13. The circuit according to claim 1, wherein the second circuit stage comprises a second current mirror, the second current mirror generating the piecewise-linear current from the first stage output voltage.

14. The circuit according to claim 13, wherein the first stage output voltage is coupled to a gate of an output transistor in the second current mirror, wherein a drain of the output transistor is the output port.

15. A system for generating different supply voltage operation modes for a memory comprising:
a first input port;
a piecewise-linear current generator;
an amplifier stage including:
an amplifier input coupled to the first input port,
an auxiliary current port, and
an amplifier output coupled to the auxiliary current port; and
an auxiliary switch coupled to the auxiliary current port, the auxiliary switch configured to (i) connect the piecewise-linear current generator to the auxiliary current port based on an auxiliary switch enable signal being asserted and (ii) disconnect the piecewise-linear current generator from the auxiliary current port based on the auxiliary switch enable signal being deasserted,
wherein magnitude of a voltage at the amplifier output is determined as (a) magnitude of a voltage of the amplifier input scaled by a gain of the amplifier when the piecewise-linear current generator is disconnected from the auxiliary current port or (b) a sum of the magnitude of the voltage of the amplifier input scaled by the gain of the amplifier and a scaled magnitude of piecewise-linear current provided by the piecewise-linear current generator when the piecewise-linear current generator is connected to the auxiliary current port.

16. The system of claim 15, further comprising:
a first switch coupled to the amplifier input and the first input port,
the first switch configured to (i) connect the first input port to the amplifier input based on a first switch enable signal being asserted and (ii) disconnect the first input port from the amplifier input based on the first switch enable signal being deasserted.

17. The system of claim 16, further comprising:
a second input port;
a second switch coupled to the amplifier input and the second input port,
the second switch configured to (i) connect the second input port to the amplifier input based on a second switch enable signal being asserted and (ii) disconnect the second input port from the amplifier input based on the second switch enable signal being deasserted.

18. The system of claim 17, wherein only one of the first switch enable signal or the second switch enable signal is asserted.

19. The system according to claim 16, wherein voltage on the second input port varies with respect to temperature.

20. The system according to claim 19, wherein voltage on the first input port is constant with respect to temperature.

21. The system according to claim 15, wherein voltage on the first input port is constant with respect to temperature.

22. The system according to claim 17, wherein the piecewise-linear current generator comprises:
a first generator input port;
a second generator input port;
a generator output port configured to provide the piecewise-linear current;
a first circuit stage coupled to the first generator input port and the second generator input port,
the first input stage configured to generate a first stage output voltage,
the first stage output voltage being proportional to a difference between a voltage on the first generator input port and a voltage on the second generator input port; and
a second circuit stage coupled to the first stage output voltage and the generator output port,
the second circuit stage configured to generate the piecewise-linear current from the first stage output voltage.

23. The system of claim 15, further comprising:
a plurality of input ports including the first input port;
a multiplexer coupled to the amplifier input and the plurality of input ports,
the multiplexer configured to (i) connect the amplifier input to one input port in the plurality of input ports based on a select signal of the multiplexer.
